(19) United States
(12) Patent Application Publication
(10) Pub. No.: US 2025/0285337 A1
(43) Pub. Date: Sep. 11, 2025

(54) METHOD FOR SHARING NEURAL NETWORK INFERENCE INFORMATION IN VIDEO COMPRESSION

(71) Applicant: InterDigital CE Patent Holdings, SAS, Paris (FR)

(72) Inventors: Franck Galpin, Thorigne-Fouillard (FR); Edouard Francois, Bourg des Comptes (FR); Thierry Dumas, Rennes (FR); Philippe Bordes, Laille (FR)

(21) Appl. No.: 18/862,806

(22) PCT Filed: Apr. 12, 2023
(86) PCT No.: PCT/EP2023/059515

§ 371 Date: Nov. 4, 2024

(30) Foreign Application Priority Data
May 4, 2022 (EP) 22305663.1
Jul. 5, 2022 (EP) 22306001.3

(51) Int. Cl. G06T 9/00; H04N 19/44; H04N 19/70

(52) U.S. Cl. CPC G06T 9/002; H04N 19/44; H04N 19/70

(57) ABSTRACT

A method comprising obtaining a video stream; obtaining metadata associated with the video stream representative of allowable margins around a patch for an inference process of a neural network based image processing tool; and, decoding the video stream applying the neural network based image processing tool.

### 1. TECHNICAL FIELD

At least one of the present embodiments generally relates to a method and a device for coding and decoding a video data using a neural network and, in particular, a method allowing sharing neural network information allowing a flexible inference process on a decoder side.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

In recently explored video coding solutions, neural network-based processing has been proposed, for example, in a post-filtering stage or for block prediction. Before being actually used, a neural network needs to be trained to be able to provide accurate results. The training of a neural network is a computation intensive process that generally requires to compare output data provided by the neural network to expected values of these output data for a large number of input data. Once trained, a neural network can apply what it has learned to input data, even if these input data were never considered during the training process. The process of applying a trained neural network to input data to obtain output data is called inference.

It is well known in the video compression domain that a process applied on an encoder side shall be replicable identically on the decoder side to ensure that there is no drift between the encoder and the decoder. The same applies to Neural Network (NN) based processes applied in a prediction loop of an encoder and a decoder. This requirement of replicability means that output data inferred on the decoder side shall be identical to output data inferred on the encoder side. In addition, it is generally expected that two decoders, possibly with different implementations, provide systematically the same result. However, it is usual to have encoders and decoders designed with different software or hardware constraints. For instance, an encoder could be able to store more data in memory than a decoder. A decoder, for which the processing speed is generally a key issue, could be able to process more data in parallel than an encoder that don't have the same processing speed issue. A decoder implemented in a smartphone generally don't have the same hardware constraint than a decoder implemented on a PC. In this context, as much as possible flexibility should be left the developers of encoders and decoders in the design of the inference process of a NN based process while ensuring first the replicability of the outputs provided by NN based in-loop process on the encoder side on the decoder side and second, that two decoders with different implementations provide identical results.

It is desirable to propose solutions allowing to overcome the above issues. In particular, it is desirable to propose a solution allowing ensuring flexibility of the inference process of a NN inference process.

### 3. BRIEF SUMMARY

In a first aspect, one or more of the present embodiments provide a method comprising:
obtaining a video stream:
obtaining metadata associated with the video stream representative of allowable margins around a patch for an inference process of a neural network based image processing tool; and,
decoding the video stream applying the neural network based image processing tool.

In an embodiment, the allowable margins depend on a receptive field depending on the neural network used in the neural network based image processing tool.

In an embodiment, the metadata comprise at least one syntax element representative of the receptive field depending on the neural network used in the neural network based image processing tool.

In an embodiment, the at least one syntax element comprises a first syntax element defining the receptive field vertically and a second syntax element defining the receptive field horizontally.

In an embodiment, a capacity of the inference process to process patches larger than a patch size considered during a definition of the neural network used in the neural network based image processing tool is determined by comparing at least one value representative of the receptive field depending on the neural network and a margin around a patch considered during a definition of the neural network used in the neural network based image processing tool.

In an embodiment, a capacity of the inference process to process patches larger than a patch size considered during a definition of the neural network used in the neural network based image processing tool is specified in the metadata by a syntax element.

In an embodiment, the metadata comprises at least one syntax element representative of at least one offset to be added to a value representative of the receptive field depending on the neural network or to a margin around a patch considered during a definition of the neural network used in the neural network based image processing tool, an offset being used responsive to a current patch to be processed by the inference process having a size smaller than a patch size considered during a definition of the neural network used in the neural network based image processing tool based on the position of the current patch.

In an embodiment, the metadata comprises at least one syntax element representative of a position of an output patch of the inference process of the neural network based image processing tool in an output tensor generated by the inference process.

In a second aspect, one or more of the present embodiments provide a method comprising:
obtaining a video stream; and,
signaling information representative of allowable margins around a patch for an inference process of a neural network based image processing tool in the form of metadata associated to the video stream.

In an embodiment, the allowable margins depend on a receptive field depending on the neural network used in the neural network based image processing tool.

In an embodiment, the metadata comprise at least one syntax element representative of the receptive field depending on the neural network used on the neural network based image processing tool.

In an embodiment, the at least one syntax element comprises a first syntax element defining the receptive field vertically and a second syntax element defining the receptive field horizontally.

In an embodiment, a capacity of the inference process to process patches larger than a patch size considered during a definition of the neural network used in the neural network based image processing tool is determined by comparing at least one value representative of the receptive field depending on the neural network and a margin around a patch considered during a definition of the neural network used in the neural network based image processing tool.

In an embodiment, a capacity of the inference process to process patches larger than a patch size considered during a definition of the neural network used in the neural network based image processing tool is specified in the metadata by a syntax element.

In an embodiment, the metadata comprises at least one syntax element representative of at least one offset to be added to a value representative of the receptive field depending on the neural network or to a margin around a patch considered during a definition of the neural network used in the neural network based image processing tool, an offset being used responsive to a current patch to be processed by the inference process having a size smaller than a patch size considered during a definition of the neural network used in the neural network based image processing tool based on the position of the current patch.

In an embodiment, the metadata comprises at least one syntax element representative of a position of an output patch of the inference process of the neural network based image processing tool in an output tensor generated by the inference process.

In an embodiment, the video stream is obtained by applying a video compression process to an original video, the video compression process comprising the neural network based image processing tool in a prediction loop of the video compression process or the neural network based image processing tool being a post-processing tool.

In a third aspect, one or more of the present embodiments provide a signal comprising metadata associated with a video stream representative of allowable margins around a patch for an inference process of a neural network based image processing tool.

In a fourth aspect, one or more of the present embodiments provide a computer program comprising program code instructions for implementing the method of the first or the second aspect.

In a fifth aspect, one or more of the present embodiments provide a non-transitory information storage medium storing program code instructions for implementing the method of the first or the second aspect.

In a sixth aspect, one or more of the present embodiments provide a device comprising electronic circuitry configured for:
obtaining a video stream;
obtaining metadata associated with the video stream representative of allowable margins around a patch for an inference process of a neural network based image processing tool; and,
decoding the video stream applying the neural network based image processing tool.

In an embodiment, the allowable margins depend on a receptive field depending on the neural network used in the neural network based image processing tool.

In an embodiment, the metadata comprise at least one syntax element representative of the receptive field depending on the neural network used in the neural network based image processing tool.

In an embodiment, the at least one syntax element comprises a first syntax element defining the receptive field vertically and a second syntax element defining the receptive field horizontally.

In an embodiment, a capacity of the inference process to process patches larger than a patch size considered during a definition of the neural network used in the neural network based image processing tool is determined by comparing at least one value representative of the receptive field depending on the neural network and a margin around a patch considered during a definition of the neural network used in the neural network based image processing tool.

In an embodiment, a capacity of the inference process to process patches larger than a patch size considered during a definition of the neural network used in the neural network based image processing tool is specified in the metadata by a syntax element.

In an embodiment, the metadata comprises at least one syntax element representative of at least one offset to be added to a value representative of the receptive field depending on the neural network or to a margin around a patch considered during a definition of the neural network used in the neural network based image processing tool, an offset being used responsive to a current patch to be processed by the inference process having a size smaller than a patch size considered during a definition of the neural network used in the neural network based image processing tool based on the position of the current patch.

In an embodiment, the metadata comprise at least one syntax element representative of a position of an output patch of the inference process of the neural network based image processing tool in an output tensor generated by the inference process.

In a seventh aspect, one or more of the present embodiments provide a device comprising electronic circuitry configured for:
obtaining a video stream; and,
signaling information representative of allowable margins around a patch for an inference process of a neural network based image processing tool in the form of metadata associated to the video stream.

In an embodiment, the allowable margins depend on a receptive field depending on the neural network used in the neural network based image processing tool.

In an embodiment, the metadata comprise at least one syntax element representative of the receptive field depending on the neural network used on the neural network based image processing tool.

In an embodiment, the at least one syntax element comprises a first syntax element defining the receptive field vertically and a second syntax element defining the receptive field horizontally.

In an embodiment, a capacity of the inference process to process patches larger than a patch size considered during a definition of the neural network used in the neural network based image processing tool is determined by comparing at least one value representative of the receptive field depending on the neural network and a margin around a patch considered during a definition of the neural network used in the neural network based image processing tool.

In an embodiment, a capacity of the inference process to process patches larger than a patch size considered during a definition of the neural network used in the neural network based image processing tool is specified in the metadata by a syntax element.

In an embodiment, the metadata comprise at least one syntax element representative of at least one offset to be added to a value representative of the receptive field depending on the neural network or to a margin around a patch considered during a definition of the neural network used in the neural network based image processing tool, an offset being used responsive to a current patch to be processed by the inference process having a size smaller than a patch size considered during a definition of the neural network used in the neural network based image processing tool based on the position of the current patch.

In an embodiment, the metadata comprise at least one syntax element representative of a position of an output patch of the inference process of the neural network based image processing tool in an output tensor generated by the inference process.

In an embodiment, the video stream is obtained by applying a video compression process to an original video, the video compression process comprising the neural network based image processing tool in a prediction loop of the video compression process or the neural network based image processing tool being a post-processing tool.

### 4. BRIEF SUMMARY OF THE DRAWINGS

FIG. 1 illustrates schematically a context in which embodiments are implemented;

FIG. 2 illustrates schematically an example of partitioning undergone by a picture of pixels of an original video:

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6 illustrates schematically an example of NN based process;

FIG. 7A represents schematically a block-based inference process and a sub-block-based inference process;

FIG. 7B represents schematically a block-based inference process and a super-block-based inference process;

FIG. 8A represents schematically an example of area expansion for a sub-block-based inference process;

FIG. 8B represents schematically an example of area expansion for a sub-block-based inference process in the case where a receptive field of the NN features different extents horizontally and vertically;

FIG. 9 represents schematically a receptive field and a border for a block;

FIG. 10 represents schematically an example of NN with tensor size variations;

FIG. 11 represents schematically an example of layout for a sub-block inference process of a bottom right sub-block;

FIG. 12 represents schematically an embodiment with an offset on output;

FIG. 13 illustrates schematically the effect of offsets introduced in a NN inference process with some tensor size variations;

FIG. 14A represents schematically an application of an embodiment during a encoding process; and,

FIG. 14B represents schematically an application of an embodiment during a decoding process.

### 5. DETAILED DESCRIPTION

The following examples of embodiments are described in the context of a video format similar to VVC (Versatile Video Coding (VVC) under development by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

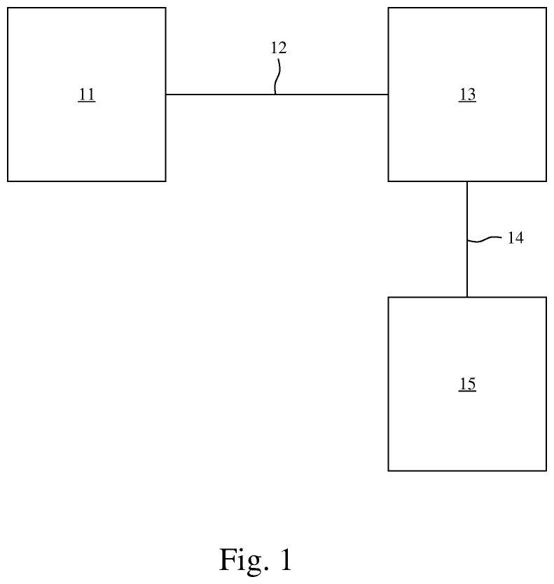

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display 15 are comprised in a TV, a computer, a tablet, a smartphone, a head-mounted display, etc.

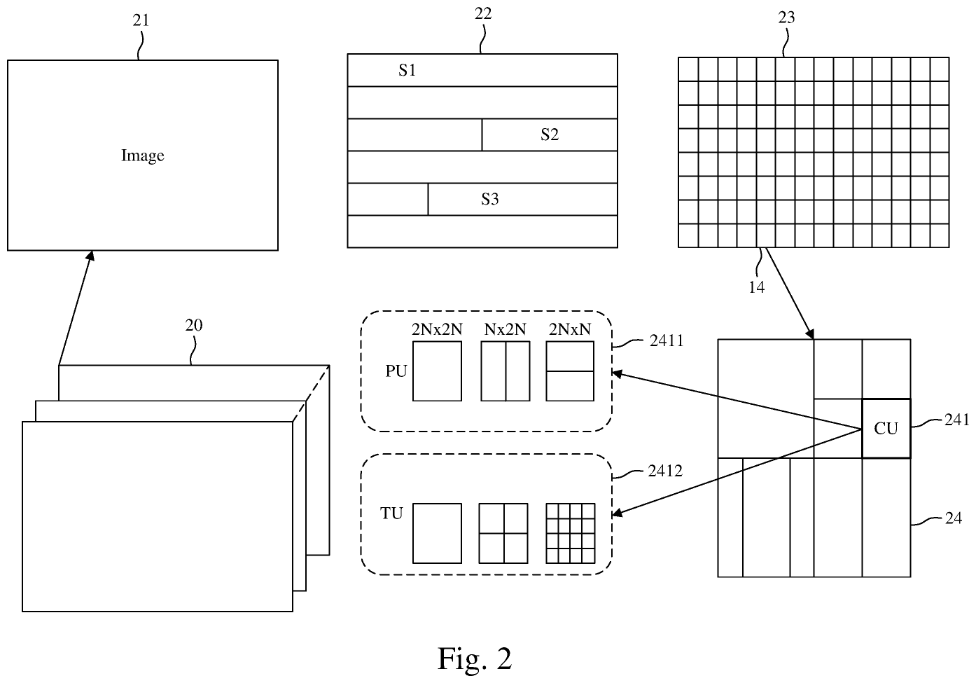

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

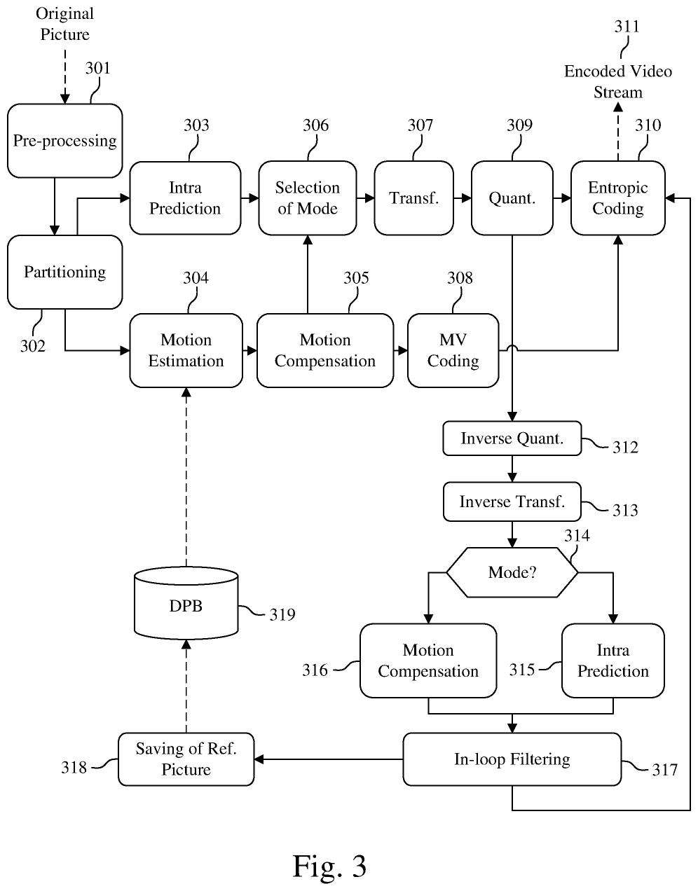

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309. Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors predictors derived from reconstructed blocks situated in a spatial and temporal vicinity of the block to be coded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

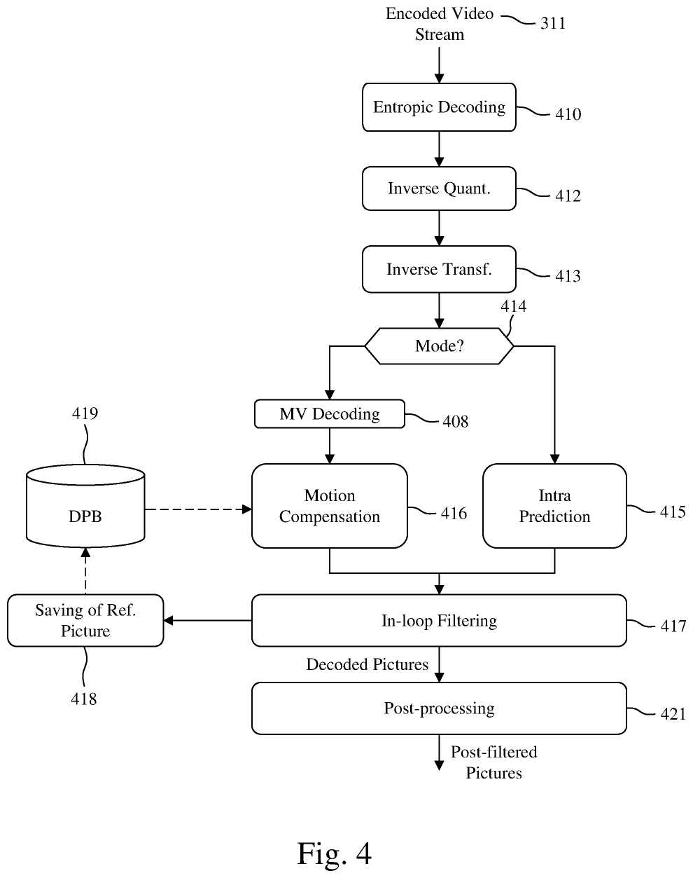

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

In recently explored video coding solutions, NN-based processing has been proposed, for example for post-filtering or for block prediction (INTRA and INTER). In addition, solution allowing exchanging information representative of a NN between an encoder and a decoder have been proposed. For instance, such information is transmitted as side information in the form of an SEI message.

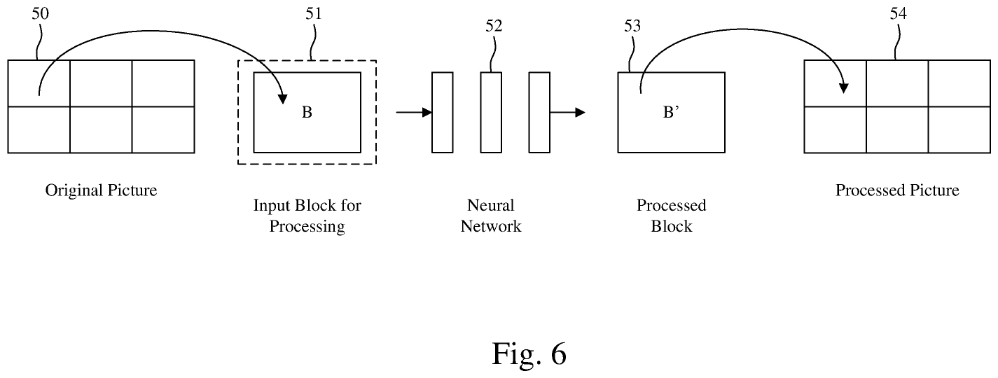

FIG. 6 illustrates schematically an example of NN based process.

In FIG. 6, a block 51 of an original picture 50 is processed. Before being processed, the block 51 is enlarged by some margin. The enlarged block is then input in a NN 52. The output of the NN is a block 53 having the same size than the block 51. The block 53 is then inserted in a picture 54 so that it can be used in an encoding or decoding process, or for display without being used in the encoding or decoding process. In some variants, the block 53 has the same size than the enlarged block. In that case, the margin is used for blending at the block boundary to reduce blocking artifacts.

Table TAB1 provide an example of SEI message nnr_post_filter allowing transporting information representative of a NN post-filtering process.

TABLE TAB1

```
nnr_post_filter( payloadSize ) {
  nnrpf_id
  nnrpf_mode_idc
  if( nnrpf_mode_idc > 0 ) {
    nnrpf_persistence_flag
    if( nnrpf_mode_idc = = 1 | | nnrpf_mode_idc = = 2 ) {
      nnrpf_purpose
      if( nnrpf_purpose = = 1 | | nnrpf_purpose = = 3 ) {
        nnrpf_out_sub_width_c_flag
        nnrpf_out_sub_height_c_flag
      }
      if( nnrpf_purpose = = 2 | | nnrpf_purpose = = 3 ) {
        nnrpf_pic_width_in_luma_samples
        nnrpf_pic_height_in_luma_samples
      }
      nnrpf_component_last_flag
      nnrpf_inp_sample_idc
      nnrpf_inp_order_idc
      nnrpf_out_sample_idc
      nnrpf_out_order_idc
      nnrpf_constant_patch_size_flag
      nnrpf_patch_size_minus1
      nnrpf_overlap
      nnrpf_complexity_idc
      if( nnrpf_complexity_idc > 0 ) {
        nnrpf_complexity_element( nnrpf_complexity_idc )
      }
      while( !byte_aligned( ) )
        nnrpf_reserved_zero_bit
    }
    if( nnrpf_mode_idc = = 1 ) {
      i = 0
      do
        nnrpf_uri[ i ]
      while( nnrpf_uri[ i++ ] != 0 )
    }
    if( nnrpf_mode_idc = = 2 | | nnrpf_mode_idc = = 3 ) {
      for( i = 0; more_data_in_payload( ); i++ )
        nnrpf_payload_byte[ i ]
    }
  }
}
```

The semantics of the syntax elements in table TAB1 is shortly described below (the reader can refer to document JVET_Z0052: Joint Video Experts Team (JVET) of ITU-T SG 16 WP 3 and ISO/IEC JTC 1/SC 29, 26th Meeting, by teleconference, 20-29 Apr. 2022, Hannuksela et al. for detailed semantics):
nnrpf_constant_patch_size_flag equal to “0” specifies that the post-processing filter accepts any patch size that is a positive integer multiple of a patch size indicated by nnrpf_patch_size_minus1 as input.
nnrpf_constant_patch_size_flag equal to “1” specifies that the post-processing filter accepts exactly the patch size indicated by nnrpf_patch_size_minus1 as input.
nnrpf_patch_size_minus1+1 specifies an horizontal and vertical sample counts of patch sizes of the post-processing filter. The value of nnrpf_patch_size_minus1 shall be in the range of “0” to “32766”, inclusive.
nnrpf_overlap specifies an overlapping horizontal and vertical sample counts of adjacent input tensors of the post-processing filter. The value of nnrpf_overlap shall be in the range of “0” to “16383”, inclusive.
nnrpf_component_last_flag indicates whether a channel is indicated as the second or last dimension in the tensor at the input to the NN and the tensor at the output of the NN.
nnrpf_pic_width_in_luma_samples and nnrpf_pic_height_in_luma_samples specify the width and height, respectively, of the luma sample array of the picture resulting by applying the post-processing filter identified by nnrpf_id to a cropped decoded output picture.
nnrpf_id contains an identifying number that may be used to identify a post-processing filter.

In this semantic, a patch is a tensor comprising picture data related for instance to a block or to the whole picture that could comprise picture samples (for instance block samples+samples in the neighborhood of the block), quantization parameters, motion information, etc. A simple patch is for example a block of samples.

Variables inpPatchWidth, inpPatchHeight, outPatchWidth, outPatchHeight, horCScaling, verCScaling, outPatchCWidth, outPatchCHeight, and overlapSize are derived as follows:
inpPatchWidth=nnrpf_patch_size_minus1+1;
inpPatchHeight=nnrpf_patch_size_minus1+1;
outPatchWidth=(nnrpf_pic_width_in_luma_samples*inpPatchWidth)/InpPicWidthInLumaSamples;
outPatchHeight=(nnrpf_pic_height_in_luma_samples*inpPatchHeight)/InpPicHeightInLumaSamples;
horCScaling=InpSubWidthC/outSubWidthC;
verCScaling=InpSubHeightC/outSubHeightC;
outPatchCWidth=outPatchWidth*horCScaling;
outPatchCHeight=outPatchHeight*verCScaling;
overlapSize=nnrpf_overlap.

InpPicHeightInLumaSamples represents the input picture Height in luma samples.

InpPicWidthtInLumaSamples represents the input picture width in luma samples.

Using the above variables, the pseudo code below gives an example of derivation process of an input tensor inputTensor, given a patch size (inpPatchWidth, inpPatchHeight) and an overlap size overlapSize:

```
for ( yP = −overlapSize; yP < inpPatchHeight + overlapSize; yP++ )
{
for ( xP = −overlapSize; xP < inpPatchWidth + overlapSize; xP++ )
{
  y = Clip3( 0, InpPicHeightInLumaSamples − 1, cTop + yP )
  x = Clip3( 0, InpPicWidthtInLumaSamples − 1, cLeft + xP )
  if( nnrpf_component_last_flag = = 0 )
  {
      inputTensor[ 0 ][ 0 ][ yP + overlapSize ][ xP +
overlapSize ] = InpY( CroppedYPic[ y ][ x ] )
  }
    else
  {
      inputTensor[ 0 ][ yP + overlapSize ][ xP +
overlapSize ][ 0 ] = InpY( CroppedYPic[ y ][ x ] )
  }
}
}
```

Clip3(a,b,c) denotes a function keeping the value of a variable b between a and c.

(cTop, cLeft) denotes coordinates of a pixel at the top-left of the current block in a luminance channel of the current picture. Note that the convention in video compression is used. This means that the column coordinate cTop is placed first in the coordinate tuple.

inputTensor denotes the tensor fed into the NN. Note that, for indexing inputTensor, the convention in Machine-Learning is used. This means that the row coordinate comes before the column coordinate. If nnrpf_component_last_flag is equal to “0”, i.e. the channel is indicated as the second dimension, the row and column are indicated as the third and fourth dimensions. If nnrpf_component_last_flag is equal to “1”, i.e. the channel is indicated as the fourth dimensions in inputTensor, the row and column are indicated as the second and third dimensions in inputTensor. inpY denotes the luminance channel of the current picture. CroppedYPic[y][x] denotes the cropped decoded output picture.

The pseudo code below depicts an example of process to derive new filtered samples given an output tensor outputTensor.

```
for ( yP = 0; yP < outPatchHeight; yP++ )
{
  for ( xP = 0; xP < outPatchWidth; xP++ )
  {
    yY = cTop * outPatchHeight / inpPatchHeight + yP
    xY = cLeft * outPatchWidth / inpPatchWidth + xP
    if ( yY < nnrpf_pic_height_in_luma_samples && xY <
nnrpf_pic_width_in_luma_samples )
    {
      if( nnrpf_component_last_flag = = 0 )
      {
        FilteredYPic[yY][xY]=
        OutY( outputTensor [ 0 ][ 0 ][ yP ][ xP ] )
      }
      else
      {
        FilteredYPic[yY][xY]=
        OutY( outputTensor [ 0 ][ yP ][ xP ][ 0 ] )
      }
    }
  }
}
```

In this pseudo code, FilteredYPic denotes the array of luminance filtered samples.

OutY and OutC denote functions for converting luma sample values and chroma sample values, respectively, output by the post-processing, to integer values at bit depths BitDepthY and BitDepthC, respectively. OutY and OutC are specified as follows:

```
  OutY( x ) = Clip3( 0, ( 1 << BitDepthY ) − 1, Round( x * ( ( 1 << BitDepthY )
− 1) ) )
  OutC( x )=Clip3( 0, ( 1 << BitDepthC ) − 1, Round( x * ( ( 1 << BitDepthC )
− 1 )) )
```

Where Round (a) rounds the value a to the closest integer value.

Typically, the SEI message nnr_post_filter describes:
A patch size, corresponding to the output size;
An input size equals to the patch size, plus some overlap size overlapSize, the overlap size being the same size on all borders of the block.

Some information is needed to describe the inputs and outputs of such NNs in order to have the decoder performing the correct and reproducible inference process.

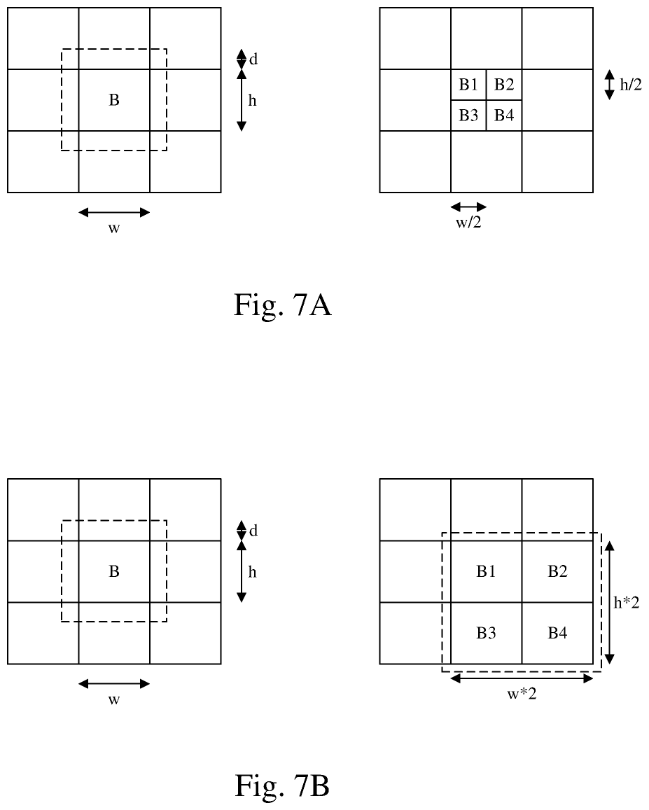

FIG. 7A represents schematically a block-based inference process and a sub-block-based inference process. In FIG. 7A, the left part shows a block B with a margin of d samples, which is used by default by the inference process. It is for example expected that inpPatchWidth and inpPatchHeight are related to the block width (w) and height (h) and overlapSize is the additional margin d.

On the right side of FIG. 7A, we show an example where the same block B is split into “4” subblocks for the inference process; for example, while the original NN was acting on the full block B, memory constraints at decoder side don't allow the processing of the full block B but requires processing smaller blocks such as sub-blocks B1 to B4 using “4” separated inference processes.

FIG. 7B represents schematically a block-based inference process and a super-block-based inference process.

FIG. 7B shows the inverse problem of FIG. 7A: while the original NN was acting on the block B, the decoder is able to process more data in parallel and process a larger block. In the FIG. 7B the processing area of the inference process is composed of 4 blocks B1 to B4, forming a super-block processed at once.

As can be seen, there is a need of flexibility in the inference process. However, in the current signaling proposed in the nnr_post_filter, some information is missing to allow such flexibility, in particular to allow handling of sub-blocks and super-blocks during an inference process while the original NN was defined using blocks. The various embodiment described below propose solutions to this problem.

In particular, the various embodiments introduce information allowing signaling to the decoder the possible block size variations at which the inference process can operate.

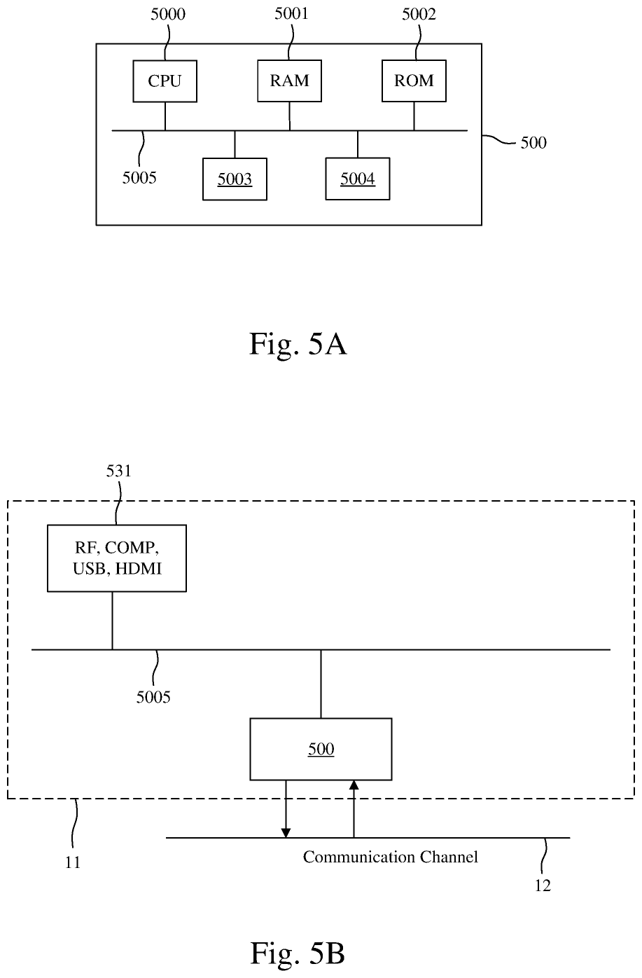

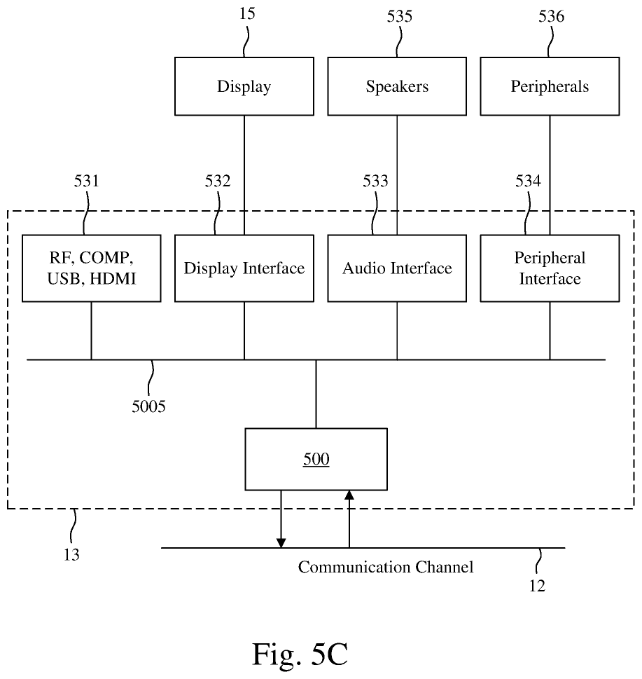

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples: a random access memory (RAM) 5001: a read only memory (ROM) 5002: a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device: at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

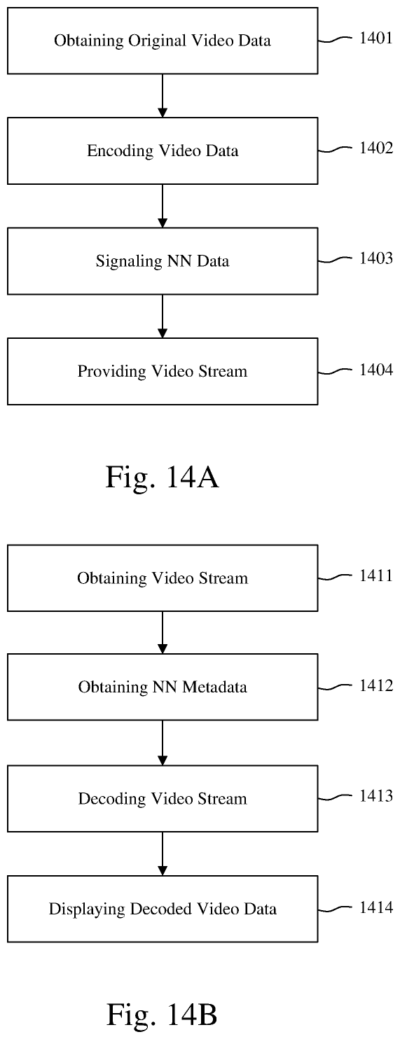

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and methods described in relation to FIG. 14A or 14B, these methods comprising various aspects and embodiments described below in this document.

All or some of the algorithms and steps of the methods of FIGS. 3, 4, 14A and 14B may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 14A and 14B.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5D.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module 500 take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for applying a coding mode based on a NN such as a NN based post-processing or in-loop filter.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for signaling to a decoder the possible block size variations at which the inference process of a NN-based post processing or in-loop filter can operate.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names. For instance, in the following, the following syntax elements names are used: nn_subblock_dx, nn_subblock_dy, nn_subblock_dxb, nn_subblock_dyb. These names could be replaced by nn_subblock dL, nn_subblock_dT, nn_subblock_dxR, nn_subblock_dyB respectively.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, various embodiments propose to signal to the decoder the various patch dimensions at which the inference process of a NN-based process can operate.

FIG. 14A represents schematically an application of an embodiment during an encoding process.

The embodiment of FIG. 14A is for instance executed by the processing module 500 of the system 11.

In a step 1401, the processing module 500 obtains original video data to encode.

In a step 1402, the processing module 500 encodes the original video data into an encoded video stream using for instance the encoding process of FIG. 3.

In a step 1403, the processing module 500 signals information, called NN information, representative of allowable margins around a patch for an inference process of a NN based image processing tool in the form of metadata associated with the encoded video stream.

In a step 1404, the processing module 500 provides the encoded video stream with the signaled information in the form of metadata to a receiving device.

In an embodiment, the encoding process of step 1402 comprises at least one NN based image processing tool such as for instance at least one NN based in loop filtering process.

In an embodiment, the signaled NN information of step 1403 provides information on each NN based image processing tool executed during the encoding process of step 1402 or on at least one NN based post-processing process to be implemented by a receiving device on decoded video data.

In an embodiment, the signaled NN information is signaled in a SEI message in which the NN information is represented in the form of syntax elements described in relation to tables TAB2, TAB3 and TAB4 below.

FIG. 14B represents schematically an application of an embodiment during a decoding process.

The embodiment of FIG. 14B is for instance executed by the processing module 500 of the system 13.

In a step 1411, the processing module 500 obtains a video stream.

In a step 1412, the processing module 500 obtains signaled NN information representative of allowable margins around a patch for at least one inference process of a NN based image processing tool in the form of metadata associated with the video stream.

In a step 1413, the processing module 500 decodes the video stream applying for instance the decoding process of FIG. 4. Each NN based image processing tool is applied by the processing module 500 either during the decoding process (for instance during the in-loop filtering process) or during a post-processing of decoded video data using the information representative of allowable margins around a patch of the inference process of the NN based image processing tool.

In a step 1414, the processing module 500 provides the decoded video data to a display module such as the display system 15.

In the following, several types of additional NN information are proposed comprising receptive field information and offset. A syntax of a SEI message adapted to transport these types of information is also proposed. However, as describe below, the transport of the NN information is not limited to SEI messages.

### Receptive Field Information:

As seen above, the NN used in an NN-based image processing tool is generally defined (trained) using a given block (or patch) size for input and output of the inference process. When changing the input or output block (or patch) size of the inference process with respect to the original input or output block (or patch) size considered when defining the NN, one needs to know what area is to be considered for the input of the inference process in order to compute an output with sample values identical to corresponding sample values of the output provided by the inference process when applied to a block (or patch) at the given size. In the following we are using the term receptive field to denote an additional margin value used to define a margin around a block (or patch) such that all values inside the block (or patch) at output only depend on the input block (or patch) plus this margin. Generally, the receptive field value depends on the NN network. In that case, we call it the NN receptive field. However, in the following we use a broader definition wherein the receptive field is a value sufficiently large to define a margin around each sample of a block (or a patch) equal or that comprise the NN receptive field. In the following we use indifferently the words block or patch, a block being a particular case of patch.

Several cases arise depending on whether sub-blocks or super-blocks are considered.

In a first embodiment, corresponding to the case illustrated in FIG. 7A, an original inference process of a NN-based image processing tool considered a block B with a given size of w×h samples and a margin overlapSize of d samples but this inference process is applied on sub-blocks of the block B applying separated inference processes. w and h could be different so that the block and sub-blocks are rectangles or equal so that the blocks and sub-blocks are square.

In the first embodiment, when the margin overlapSize is less than the receptive field of the NN (i.e. the NN receptive field), an asymmetric margin around the subblock is used.

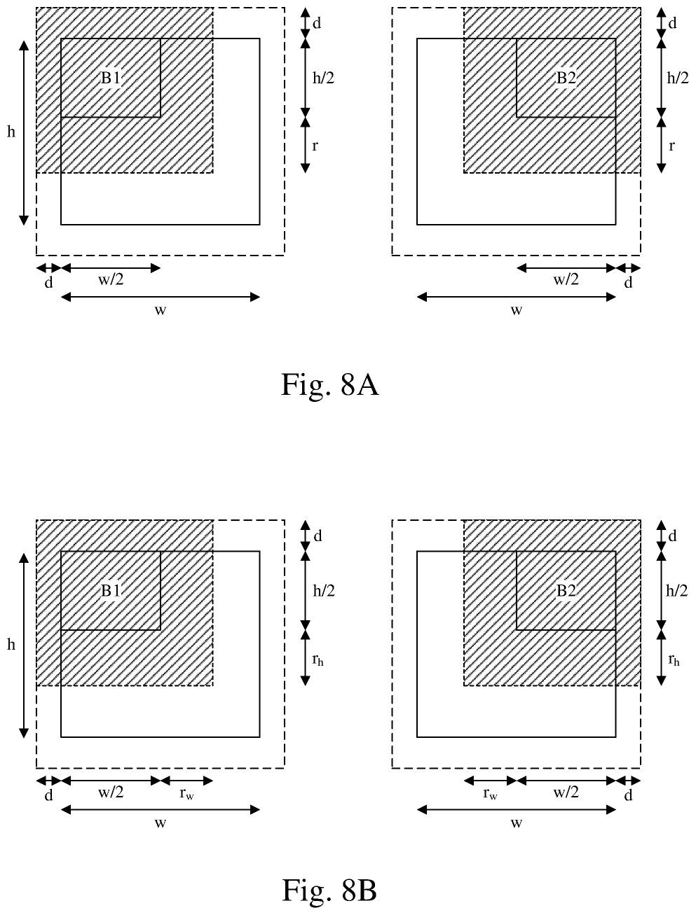

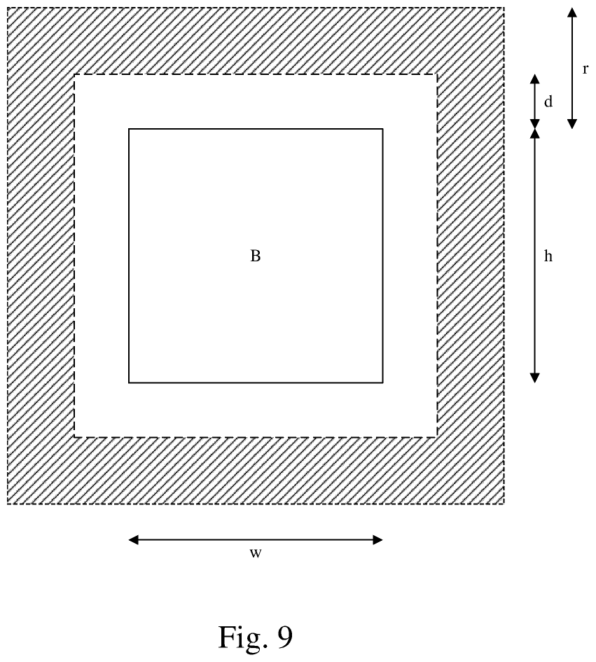

FIG. 8A represents schematically an example of area expansion for a sub-block-based inference process.

In FIG. 8A, the original block B is split in “4” square sub-blocks of equal size B1 to B4. FIG. 8A represents the two top sub-blocks B1 and B2. For sub-block B1:
the top and left margins are d, the same margin as for the original block B;
the bottom and right margins are defined with the single value r, where r corresponds to the receptive field of the NN.

For sub-block B2, the left and bottom margins use the receptive field size r, the right and top margins using the margin value d.

One can note that the block B could correspond to a whole picture.

In terms of syntax, in the first embodiment, it is proposed to add a syntax element nn_receptive_field to the existing syntax of SEI message described in table TAB1 for coding a value representative of the receptive field value r. In that case, margin around a patch (such as a block B1, B2, B3 or B4) is defined by the margin value d and the receptive field value r provided by the syntax element nn_receptive_filed.

In a variant of the syntax adapted to the first embodiment, the syntax element nn_receptive_field is replaced by a syntax element nn_receptive_field_plus1. The value of the receptive field is then nn_receptive_field_plus1-1. A value of “−1” of the receptive field (i.e. nn_receptive_field_plus1=0) indicates that the NN does not have a receptive field.

In a variant of the first embodiment, depending on an architecture of the NN, the receptive field may have different extents horizontally and vertically. For instance, if the NN contains a convolutional layer with a horizontal convolutional stride being twice larger than a vertical convolutional stride, this convolutional layer may make the receptive field of the NN different horizontally and vertically. This case is considered in FIG. 8B.

FIG. 8B represents schematically an example of area expansion for a sub-block-based inference process in the case where a receptive field of the NN features has different extents horizontally and vertically.

For sub-block B1:
the top and left margins are d, the same margin as for the original block B:
the bottom margin is defined as rₕ and the right margin is defined as r_{w}, rₕ and r_{w} defining respectively the receptive field vertically and horizontally.

For sub-block B2, the left margin equals r_{w}, the bottom margin equals rₕ, the right and top margins using the margin d.

In terms of syntax in relation to the variant of the first embodiment, it is proposed to add a syntax element nn_receptive_field_vertically for coding the value rₕ and a syntax element nn_receptive_field_horizontally for coding the value r_{w} to the existing syntax of table TAB1.

In a second embodiment, corresponding to the case illustrated in FIG. 7B, an original inference process of a NN-based image processing tool considered a block B with a given size of w×h samples and a margin overlapSize of d samples but this inference process is applied on a super-block of the block B. The super-block B could have any size comprising a size corresponding to the whole frame comprising the block B. In the case of the second embodiment, in order to recover the same results as for the processing based on the block B, the margin needs to be larger or equal to the receptive field of the NN.

FIG. 9 represents schematically a receptive field and a border for a block B.

In FIG. 9, a block with a margin of d samples is shown, as well as a receptive field of r samples. When d is less than r, the samples in the margin between d and r are assumed to be equal to a certain value. Typically, a zero-padding is used, that is samples outside the block are assumed to be zero. Other padding can be used (mirroring etc.). In that case, (when d is less than r), the block cannot be processed at a larger size than the one defined in the original NN without changing the samples value.

In a first variant of the second embodiment, the capability to process blocks larger than the block size considered during the definition of the NN network used in the NN based image processing tool is determined by comparing the receptive_field value r to the overlap overlapSize value d. If d<r the block cannot be processed at a larger size. Otherwise, if d≥r, the block can be processed at a larger size.

In a variant of the second embodiment, the capability to process block larger than the block size considered during the definition of the NN network used in the NN based image processing tool is explicitly signaled by adding a flag nn_possible_superblock_processing_flag to the syntax of table TAB1.

### Offset Information:

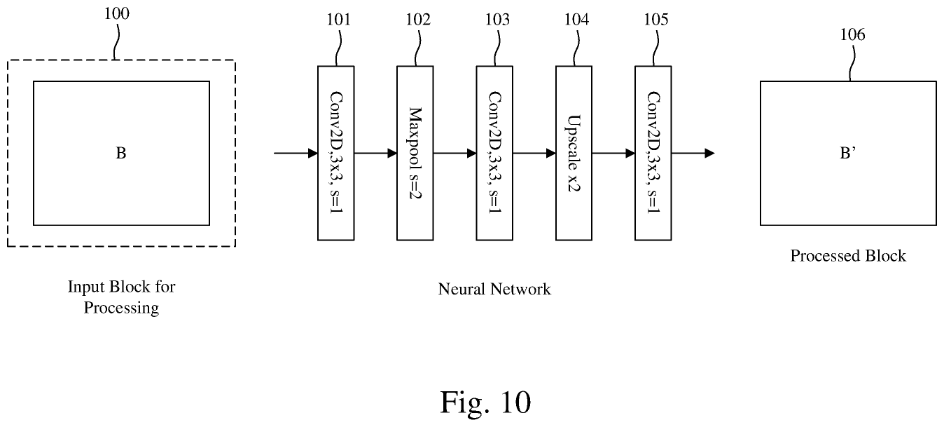

An issue arises when the NN used by the NN-based image processing tool contains some tensor size variations along the NN inference process. FIG. 10 represents schematically an example of NN with tensor size variations;
We assume an input tensor in the form of a 3D (3 dimensional) tensor corresponding to a square block B 100 of size w×w with a depth D as input of an NN inference process;
First a 2D convolution using a kernel of size 3×3 with a stride of “1” is applied to the input tensor in a step 101. A stride is a parameter of the NN that modifies the amount of movement over the image or video of a convolution kernel.
A max pooling with a stride of “2” is then applied to the output tensor of step 101 in a step 102. A Max pooling is a pooling operation that calculates the maximum value for sub-parts of a tensor and uses it to create a down-sampled (pooled) tensor. It is usually used after a convolutional layer. It adds a small amount of translation invariance, i.e. translating the picture by a small amount does not significantly affect the values of most pooled outputs. After this max pooling layer the sub-sampled tensor is w/2×w/2×D where /2 is an integer division and D a depth of the sub-sampled tensor. On can note that the max pooling can be replaced by any downscaling layer (convolution with stride, other pooling with stride etc.).
a 2D convolution using a kernel of size 3×3 with a stride of “1” is applied to the down-sampled tensor in step 103;
an upscaling is applied in a step 104, for example a pixel shuffle method (trading a depth of the tensor for the width/height), a transpose convolution with a stride of “2” or an interpolation etc. After the up-scaling, the up-scaled tensor size is w×w×D′ where D′ is the depth of the tensor.
In a step 105, a 2D convolution using a kernel of size 3×3 with a stride of “1” is applied to the up-scaled tensor to obtain an output tensor. A resulting block B′ is then extracted from the output tensor.

Some output tensor characteristics may differ from the input tensor characteristics when the NN inference process comprises some internal tensor size variations, which is typically the case of the NN inference process of FIG. 10.

These characteristics comprise the output tensor size which may differ from the input tensor size and/or the samples locations in the output tensor may differ from the corresponding samples locations in the input tensor from an offset value. These differences may be induced by parameters of the NN such as the stride policy in the NN inference process, the eventual use of padding, etc.

For example, let's consider the case illustrated in FIG. 10:
original block size of block B is 16×16, with a margin of 2, i.e. the input size is 20×20;
after the max pooling step 102, the sub-sampled tensor size is 10×10×D;
after the upscaling step 104 the up-scaled tensor size is back to 20×20;

For this particular NN, the receptive field is “5”.

When considering the case of the first embodiment with sub-blocks B1 to B4, the input size would be:
sub-block size=16/2×16/2=8×8;

For the top left sub-block B1:
the margin is “2”;
The bottom and right margin is “5” (equal to the receptive field);
It gives a input tensor size of (2+8+5)×(2+8+5)=15×15;

In the case of sub-block B1, the output sub-block B1″ resulting from the application of the process of FIG. 10 to the input sub-block B1 is similar to the sub-block B1′ extracted from the block B′ resulting from the application of the process of FIG. 10 to the full block B.

However, for the top-right sub-block B2:
the top right border, the margin is 2:
The bottom and left margin is 5 (equal to the receptive field):
It gives a full input tensor size of (5+8+2)×(2+8+5)=15×15

But, because of offset introduced during the process of FIG. 10, the output sub-block B2″ resulting from the application of the process of FIG. 10 to the sub-block B2 is different from the sub-block B2′ extracted from the block B′.

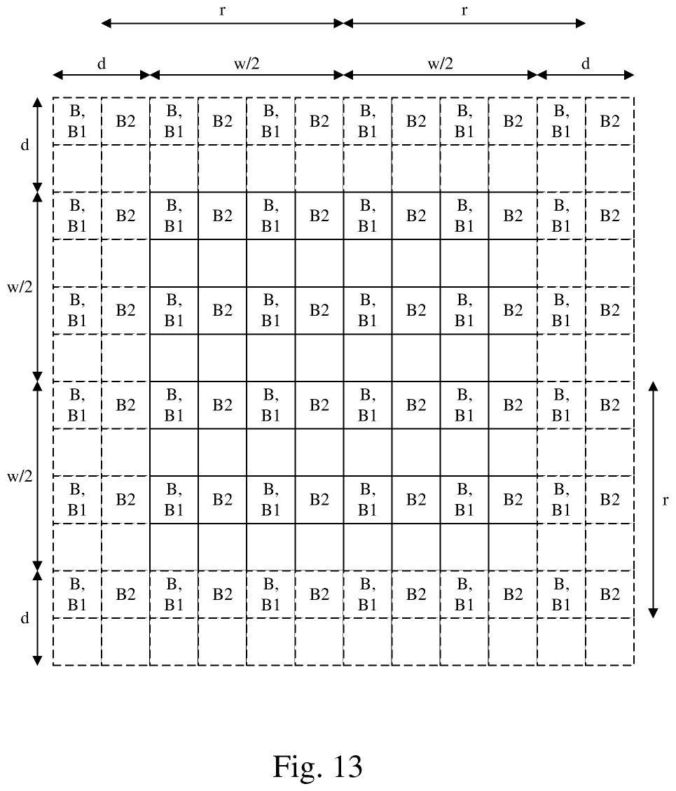

FIG. 13 illustrates schematically the effect of offsets introduced in a NN inference process with some tensor size variations.

In that case block the size of block B is 8×8, the value of the margin d is “2” and the value of the receptive field r is “5”. As in FIG. 7A, block B is split into four sub-blocks B1 to B4 of size 4×4. The margin around block B is therefore of two samples. The left and top margins of the sub-block B1 is two samples. The right and bottom margins of the sub-block B1 is five samples. The right and top margins of the sub-block B2 is two samples. The left and bottom margins of the sub-block B2 is five samples.

The block B, and the sub-blocks B1 and B2 are input to the NN inference process of FIG. 10 supposing that this process had been designed to process blocks of size 8×8. In the case of block B the input tensor size is (2+2+8)×(2+2+8)=12×12. In the case of blocks B1 and B2, the input tensors size is (2+4+5)×(2+4+5)=11×11. As seen in the description of FIG. 10, the NN inference process comprises a down-scaling step 102. We suppose that the downscaling process used in the case of FIG. 13 takes one sample out of two of the input tensor starting with the upper-left sample. In FIG. 13, samples marked with a “B” represents samples kept by the down-sampling process of step 102 when applied to block B. Samples marked with a “B1” represents samples kept by the down-sampling process of step 102 when applied to sub-block B1. Samples marked with a “B2” represents samples kept by the down-sampling process of step 102 when applied to sub-block B2. As can be seen, the same samples are kept by the down-sampling process when the NN inference process of FIG. 10 is applied to block B and sub-block B1. However, the samples kept by the down-sampling process when the NN inference process of FIG. 10 is applied to sub-block B2 are different from the samples kept by the down-sampling process when the NN inference process of FIG. 10 is applied to block B. This explains why the application of the NN inference process of FIG. 10 when applied to sub-block B2 cannot provide the same result than the application of the NN inference process of FIG. 10 when applied to block B.

In this example, in order to recover systematically the same sub-blocks when applying the inference process of FIG. 10 at the full block level or at the sub-block level, the following parameters need to be used:
For the top right border, the margin shall be “2”;
The bottom margin shall be “5”;
The left margin shall be 5+1;
It gives a full input tensor size of (6+8+2)×(2+8+5)=16×15

As can be seen in this example, more parameters are needed to be signaled to better take into account these offsets. In a third embodiment, additional parameters specify the input size of the sub-blocks as well as offsets in the output tensor.

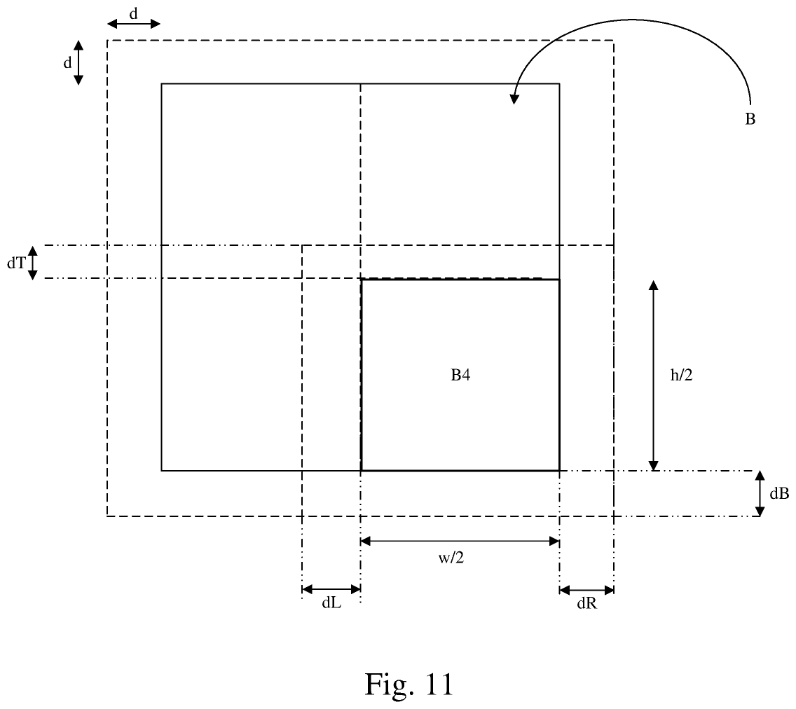

Examples of added parameters according to a first variant of the third embodiment are illustrated in relation to FIG. 11 and provided in table TAB2 below.

FIG. 11 represents schematically an example of layout for a sub-block inference process of a bottom right sub-block.

In FIG. 11, we show an example where the original block B, with a margin (overlapSize) of d, is processed using “4” sub-blocks. In FIG. 11, we show the parameters for the bottom right subblock B4. dT, dB, dL, dR are top, bottom, left and right margins respectively. These margins are typically obtained by adding/subtracting offset values ox and oy to the horizontal and vertical margin/receptive field values of the original block.

Using offsets allow encoding the margins with respect default parameters (depending on the original margin and receptive field). By denoting r the receptive field of the NN, and d the original margin, we use the following equations to compute the margins of the “4” sub-blocks B1-B4 of a block B (as shown in FIG. 7A):
Block B1:
   dT=d+oy1;
   dL=d+ox1;
   dB=r;
   dR=r;
Block B2:
   dT=d+oy2;
   dL=r+ox2;
   dB=r;
   dR=d;
Block B3:
   dT=r+oy3;
   dL=d+ox3;
   dB=d;
   dR=r;
Block B4:
   dT=r+oy4;
   dL=r+ox4;
   dB=d;
   dR=d;

Typically, the parameters are:
ox1=oy1=0;
ox2=1, oy2=0;
ox3=0, oy3=1;
ox4=oy4=1;

In a second variant of the third embodiment, the left offset dx1 (respectively the top offset dy1) and the right offset dx1b (respectively the bottom offset dy1b) are different:
Block B1:
   dT=d+oy1;
   dL=d+ox1;
   dB=r+oy1b;
   dR=r+ox1b;
Block B2:
   dT=d+oy2;
   dL=r+ox2;
   dB=r+oy2b;
   dR=d+ox2b;
Block B3:
   dT=r+oy3;
   dL=d+ox3;
   dB=d+oy3b;
   dR=r+ox3b;
Block B4:
   dT=r+oy4;
   dL=r+ox4;
   dB=d+oy4b;
   dR=d+ox4b;

The second variant of the third embodiment is associated with an additional syntax provided in table TAB3.

In a variant, the margins are defined in absolute instead of being defined relatively to a margin, i.e. for each sub-block Bi, the margins dT, dB, dL and dR are signaled.

One can note that the input size of the sub-blocks is derived from the size of the original block.

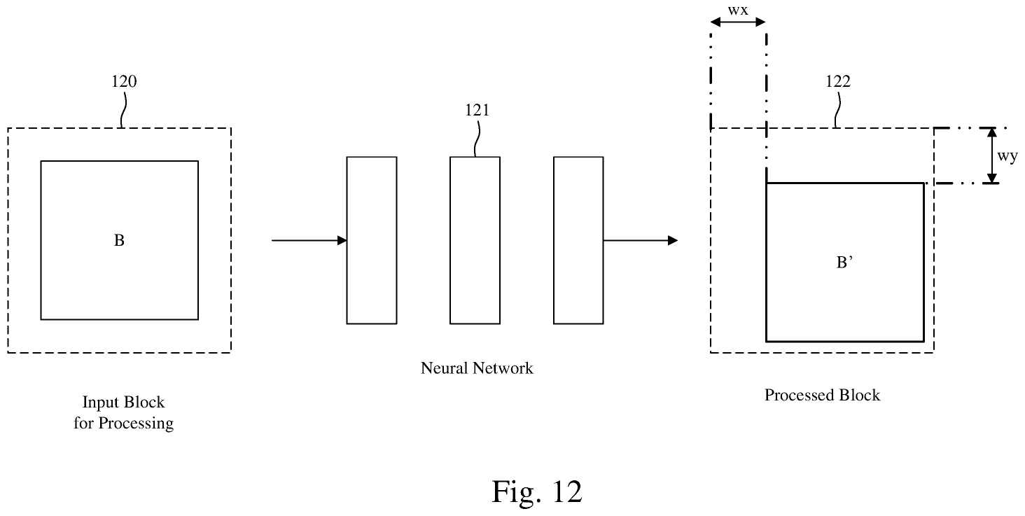

In a third variant of the third embodiment, additional parameters are signaled for even more flexibility. FIG. 12 represents schematically an embodiment with offsets wx and wy on the output. wx and wy represent respectively vertical and horizontal offsets of the block inside the output tensor to extract the output block B′. In other words wx and wy are representative of a position of the output block B′ in the output tensor of the NN inference process. The above offsets are typically applied when an output size of a layer in a NN, for example a convolution layer, is reduced compared to the input tensor because only operations using samples inside the input tensor are used.

TABLE TAB2

```
nnr_post_filter( payloadSize ) {
  ...
  nn_receptive_field
  nn_possible_superblock_processing
  nn_possible_halfblock_processing
  if (nn_possible_halfblock_processing) {
        for(i=1;i<=4;i++) {
          nn_half_block_dx[i]
          nn_half_block dy[i]
        }
    }
      ...
}
```

Table TAB2 represent a first embodiment of an additional syntax to be added to the syntax of table TAB1. The following semantic is used:
nn_receptive_field: specify the half size of the receptive field size of the network. It represents the number of samples around the input so that translating the input gives the same useful output. Note that the border or overlap parameter is usually less or equal to the receptive field. nn_receptive_field value is in the range “0” to nn_patch_size/2. Assuming nn_patch_size the input patch size, border_size the border around the input patch, it is assumed that the output patch size is equal to nn_patch_size, obtained by cropping the center part of the output tensor.
nn_possible_superblock_processing: when set to “1”, it allows a decoder to perform a processing on larger block size using a multiple of nn_patch_size and add the border_size. For example, an input tensor would have the width and height:
   W=nn_patch_size*2+border_size;
   H=nn_patch_size*2+border_size.
nn_possible_halfblock_processing: when set to “1”, it allows a decoder to perform a processing on smaller (half) block size. For example, an input tensor would have the width and height (without the margins):
   W=nn_patch_size/2;
   H=nn_patch_size/2;
We assume the sub-block Bi (with Bi from “1” to “4”) is as described in FIG. 7A.
nn_half_block_dx[i] and nn_half_block_dy[i] are used in the first variant of the third embodiment to derive the border of each subblock Bi by setting oxi=nn_half_block_dx[i] and oyi=nn_half_block_dy[i]. r is set to nn_receptive_field and d to the border_size:

Output samples results are taken by cropping the output using the margins defined as input. By default, the output samples are located at the position of the input samples, removing the added margins.

Table TAB3 represent a second embodiment of an additional syntax to be added to the syntax of table TAB1.

TABLE TAB3

```
nnr_post_filter( payloadSize ) {
  ...
  nn_receptive_field
  nn_possible_superblock_processing
  nn_possible_halfblock_processing
  if (nn_possible_halfblock_processing) {
        for(i=1;i<=4;i++) {
          nn_half_block_dx[i]
          nn_half_block dy[i]
          nn_half_block_dxb[i]
          nn_half_block dyb[i]
        }
    }
      ...
}
```

The following semantic is used:
nn_half_block_dx[i], nn_half_block_dy[i], nn_half_block_dxb[i] and nn_half_block_dyb[i] are used in the second variant of the third embodiment to derive the border of each subblock Bi by setting oxi=nn_half_block_dx[i], oyi=nn_half_block_dy[i], oxib=nn_half_block_dxb[i] and oyib=nn_half_block_dyb[i]. r is set to nn_receptive_field and d to the border_size.

Table TAB4 represent a third embodiment of an additional syntax to be added to the syntax of table TAB1. The additional syntax of table TAB4 shows that extension to quarter or even smaller sub-block sizes is straightforward: margin around each subblocks is signaled using the same syntax, as shown in the table below for a quarter size.

TABLE TAB4

```
nnr_post_filter( payloadSize ) {
  ...
  nn_receptive_field
  nn_possible_superblock_processing
  nn_possible_halfblock_processing
  if (nn_possible_halfblock_processing) {
        for(i=1;i<=4;i++) {
          nn_half_block_dx[i]
          nn_half_block dy[i]
          nn_half_block_dxb[i]
          nn_half_block dyb[i]
        }
    }
      ...
  if (nn_possible_quarterblock_processing) {
        for(i=1;i<=16;i++) {
          nn_quarter_block_dx[i]
          nn_quarter _block dy[i]
          nn_quarter_block_dxb[i]
          nn_quarter_block dyb[i]
        }
    }
```

The additional syntax of tables TAB2, TAB3 and TAB4 could be applied to a post-processing NN inference process or, to any NN inference process in the prediction loop of an encoder or a decoder such as an in-loop filter.

One can note that, until now in this disclosure, block B is split in four or “16” sub-blocks. Table TAB5 below provides a flexible syntax to be added to the syntax of table TAB1 allowing splitting a block in 4, 16, 64, 256, etc sub-blocks.

TABLE TAB5

```
nnr_post_filter( payloadSize ) {
  ...
  nn_receptive_field
  nn_possible_superblock_processing
  nn_possible_subblock_processing
  if (nn_possible_subblock_processing) {
      nn_nb subdivision_minus1
for(level=0;level<nn_nb subdivision_minus1+1;level++) {
        for(i=0;i<pow(4, nn_nb subdivision_minus1+1);i++) {
          nn_subblock_dx[level][i]
          nn_sublock dy[level] [i]
          nn_subblock_dxb[level] [i]
          nn_subblock dyb[level] [i]
        }
    }
      ...
```

In Table TAB5, nn_nb subdivision_minus1+1 is a number of possible recursive division of a patch. Each offset for each level is read in the corresponding variable nn_sublock dzz[level][i] where dzz is either dx, dy, dxb or dyb. The value of nn_nb subdivision_minus1+1 is in the range “1” to floor (log 2(nn_patch_size)). When not present, the value is inferred to “0”.

When a subblock is possible, for a particular level L, with L in the range “1” to nn_nb_subdivision_minus1+1, following the process already described, each subblock of size (nn_patch_size>>L), is used as an input of the NN with the following margins:
dT[i]=defaultMarginT+nn_subblock_dy[L][i];
dL[i]=defaultMarginL+nn_subblock_dx[L][i];
dB[i]=defaultMarginB+nn_subblock_dyb[L][i];
dR[i]=defaultMarginR+nn_subblock_dxb[L][i].

As a reminder dT, dL, dB and dR are the top, left, bottom and right margins respectively and:
defaultMarginT is equal to d (original block border_size) for subblocks at the top of the original block, and r (the receptive field) otherwise;
defaultMarginL is equal to d (original block border_size) for subblocks at the left of the original block, and r (the receptive field) otherwise;
defaultMarginR is equal to d (original block border_size) for subblocks at the right of the original block, and r (the receptive field) otherwise;
defaultMarginB is equal to d (original block border_size) for subblocks at the bottom of the original block, and r (the receptive field) otherwise.

Table TAB6 provides the same flexible syntax when the syntax element nn_receptive_field is replaced by a syntax element nn_receptive_field_plus1.

```
TABLE TAB6
nnr_post_filter( payloadSize ) {
  ...
  nn_receptive_field_plus1;
  if (nn_receptive_field_plus1>0) {
      nn_possible_superblock_processing
      nn_possible_subblock_processing
      if (nn_possible_subblock_processing) {
        nn_nb subdivision_minus 1
        for(level=0;level<nn_nb subdivision_minus1+1;level++) {
          for(i=0;i<pow(4, nn_nb subdivision_minus1+1);i++) {
            nn_subblock_dx[level][i]
            nn_sublock dy[level] [i]
            nn_subblock_dxb[level] [i]
            nn_subblock dyb[level] [i]
          }
        }
    }
      ...
```

In addition, until now, the shape of the sub-blocks is dependent of the shape of the block B. If the block B is a square, then the sub-blocks are squares. If the block B is a rectangle, then the sub-blocks are rectangles. The syntax proposed in this disclosure is also adapted to the case where the shape of the sub-blocks is independent of the shape of the block B. For instance:
a square block B can be split in rectangle sub-blocks.
a rectangular block B can be split in square sub-blocks.
a block B can also be split in any combination of square and rectangular sub-blocks of various sizes.

This disclosure has described various pieces of NN information, such as for example syntax, that can be transmitted or stored, for example. This NN information can be packaged or arranged in a variety of manners, including for example manners common in video standards such as putting the NN information into a SEI message such as the SEI message(s) described in this disclosure. Other manners are also available, including for example manners common for system level or application level standards such as putting the NN information into:
SDP (session description protocol), a format for describing multimedia communication sessions for the purposes of session announcement and session invitation, for example as described in RFCs and used in conjunction with RTP (Real-time Transport Protocol) transmission.
DASH MPD (Media Presentation Description) descriptors, for example as used in DASH and transmitted over HTTP. A descriptor is associated to a representation or collection of representations to provide additional characteristics to the content representation.
RTP header extensions, for example as used during RTP streaming.
ISO Base Media File Format, for example as used in OMAF and using boxes which are object-oriented building blocks defined by a unique type identifier and length also known as atoms in some specifications.
HLS (HTTP live Streaming) manifest transmitted over HTTP. A manifest is associated to a version or collection of versions of a content to provide characteristics of the version or collection of versions.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.

Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1-37. (canceled)

38. A method comprising:
obtaining a video stream;
obtaining metadata associated with the video stream representative of margins around a patch for an inference process of a neural network based image processing tool; and
decoding the video stream applying the neural network based image processing tool using the metadata, wherein the margins depend on a receptive field depending on a neural network used in the neural network based image processing tool.

39. The method of claim 38, wherein the metadata comprise at least one syntax element representative of the receptive field.

40. The method of claim 39, wherein the at least one syntax element comprises a first syntax element defining the receptive field vertically and a second syntax element defining the receptive field horizontally.

41. The method of claim 38, wherein a capacity of the inference process to process patches larger than a patch size considered during a definition of the neural network used in the neural network based image processing tool is specified in the metadata by a syntax element.

42. The method of claim 38, wherein the metadata comprises at least one syntax element representative of a position of an output patch of the inference process of the neural network based image processing tool in an output tensor generated by the inference process.

43. A method comprising:
obtaining a video stream; and
signaling information representative of margins around a patch for an inference process of a neural network based image processing tool in the form of metadata associated to the video stream, wherein the margins depend on a receptive field depending on a neural network used in the neural network based image processing tool.

44. The method of claim 43, wherein the metadata comprise at least one syntax element representative of the receptive field.

45. The method of claim 44, wherein the at least one syntax element comprises a first syntax element defining the receptive field vertically and a second syntax element defining the receptive field horizontally.

46. The method of claim 43, wherein a capacity of the inference process to process patches larger than a patch size considered during a definition of the neural network used in the neural network based image processing tool is specified in the metadata by a syntax element.

47. The method of claim 43, wherein the metadata comprises at least one syntax element representative of a position of an output patch of the inference process of the neural network based image processing tool in an output tensor generated by the inference process.

48. The method of claim 43, wherein the video stream is obtained by applying a video compression process to an original video, the video compression process comprising the neural network based image processing tool in a prediction loop of the video compression process or the neural network based image processing tool being a post-processing tool.

49. A device comprising electronic circuitry configured for:
obtaining a video stream;
obtaining metadata associated with the video stream representative of margins around a patch for an inference process of a neural network based image processing tool; and
decoding the video stream applying the neural network based image processing tool using the metadata, wherein the margins depend on a receptive field depending on a neural network used in the neural network based image processing tool.

50. The device of claim 49, wherein the metadata comprise at least one syntax element representative of the receptive field.

51. The device of claim 50, wherein the at least one syntax element comprises a first syntax element defining the receptive field vertically and a second syntax element defining the receptive field horizontally.

52. The device of claim 49, wherein a capacity of the inference process to process patches larger than a patch size considered during a definition of the neural network used in the neural network based image processing tool is specified in the metadata by a syntax element.

53. The device of claim 49, wherein the metadata comprise at least one syntax element representative of a position of an output patch of the inference process of the neural network based image processing tool in an output tensor generated by the inference process.

54. A device comprising electronic circuitry configured for:
obtaining a video stream; and
signaling information representative of margins around a patch for an inference process of a neural network based image processing tool in the form of metadata associated to the video stream, wherein the margins depend on a receptive field depending on a neural network used in the neural network based image processing tool.

55. The device of claim 54, wherein the metadata comprise at least one syntax element representative of the receptive field.

56. The device of claim 55, wherein the at least one syntax element comprises a first syntax element defining the receptive field vertically and a second syntax element defining the receptive field horizontally.

57. The device of claim 54, wherein a capacity of the inference process to process patches larger than a patch size considered during a definition of the neural network used in the neural network based image processing tool is specified in the metadata by a syntax element.
